(19) United States
(12) Patent Application Publication
(10) Pub. No.: US 2015/0351013 A1
(43) Pub. Date: Dec. 3, 2015

(54) Station and Method for Location Aware Network Selection

(71) Applicant: APPLE INC., CUPERTINO, CA (US)

(72) Inventors: Qin ZHANG, CUPERTINO, CA (US); Longda XING, Cupertino, CA (US); Yifan ZHU, Cupertino, CA (US); Umesh SHUKLA, Cupertino, CA (US)

(73) Assignee: APPLE INC., CUPERTINO, CA (US)

(21) Appl. No.: 14/292,417

(22) Filed: May 30, 2014

(51) Int. Cl. H04W 48/16; H04W 4/02

(52) U.S. Cl. CPC H04W 48/16; H04W 4/021

(57) ABSTRACT

A method, station and computer readable storage medium used for location aware network selection. A station determines a geographic location of the station, determines at least one predetermined Public Land Mobile Network (PLMN) in the geographic location by comparing the geographic location to a database including stored geographic locations and PLMNs known to be present within each of the geographic locations, performs a targeted scan on select channels corresponding to the at least one predetermined PLMN to identify at least one available PLMN from among the at least one predetermined PLMN and selects one of the at least one available PLMN for the station to join.

### BACKGROUND INFORMATION

A station may be configured to communicate wirelessly with a network by associating with a base station (BS) of the network. The station may include a network application that is executed to perform this functionality of joining the network and associating with the BS. The network may operate using a predetermined radio access technology (RAT). When more than one network and/or more than one BS is available for association in a given location of the station, the station may connect to any one of these BSs as long as the station is configured to operate on the corresponding RAT.

Prior to joining a network, the station may perform a full band scan to identify any available network at the location that the station is disposed. However, depending on the geographic location such as a country, the RATs used by the various networks may operate on a wide range of channels (i.e., group of continuous frequencies). Therefore, the station may be required to scan across this entire range to identify the available networks. This causes the network selection process to require more time and more power as the possible RATs being supported by network providers is increasing.

### BRIEF DESCRIPTION OF THE DRAWINGS

FIG. 1 shows an exemplary network arrangement including a plurality of networks using respective radio access technologies.

FIG. 2 shows the exemplary station configured to perform a network selection based upon a location of the station.

FIG. 3 shows an exemplary database used in a network selection based upon a location of the station.

FIG. 4 shows an exemplary method for performing a network selection based upon a location of the station.

FIG. 5A shows a first exemplary signaling diagram to perform a network selection based upon a location of the station.

FIG. 5B shows a second exemplary signaling diagram to perform a network selection based upon a location of the station.

### DETAILED DESCRIPTION

The exemplary embodiments describe a method performed by a station, the method including determining a geographic location of the station, determining at least one predetermined Public Land Mobile Network (PLMN) in the geographic location by comparing the geographic location to a database including stored geographic locations and PLMNs known to be present within each of the geographic locations, performing a targeted scan on select channels corresponding to the at least one predetermined PLMN to identify at least one available PLMN from among the at least one predetermined PLMN and selecting one of the at least one available PLMN for the station to join.

The exemplary embodiments further describe a station having a transceiver configured to establish a connection with a Public Land Mobile Network (PLMN) and a processor. The processor and transceiver are configured to perform a PLMN selection by determining a geographic location of the station, determining at least one predetermined Public Land Mobile Network (PLMN) in the geographic location, performing a targeted scan on select channels corresponding to the at least one predetermined PLMN to identify at least one available PLMN from among the at least one predetermined PLMN and selecting one of the at least one available PLMN for the station to join.

The exemplary embodiments also describe a non-transitory computer readable storage medium with an executable program stored thereon. The program instructs a microprocessor to perform operations including determining a geographic location of a station, determining at least one predetermined Public Land Mobile Network (PLMN) in the geographic location, performing a targeted scan on select channels corresponding to the at least one predetermined PLMN to identify at least one available PLMN from among the at least one predetermined PLMN and selecting one of the at least one available PLMN for the station to join.

The exemplary embodiments may be further understood with reference to the following description and the related appended drawings, wherein like elements are provided with the same reference numerals. The exemplary embodiments are related to a station and method for a location aware network selection. Specifically, a station may scan for networks based upon select channels corresponding to known networks that are present in a location of the station. Therefore, the station may conserve power and reduce a time used to join a network. Power may be conserved and time may be reduced from narrowing a manner in which the scan is performed to identify the available networks in the location of the station.

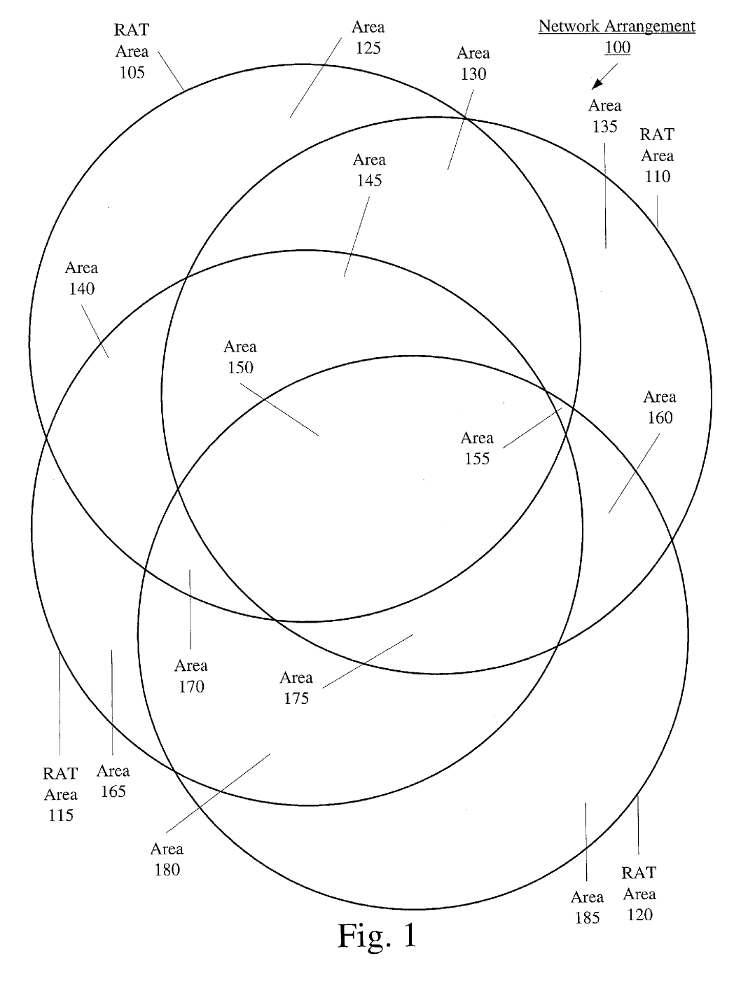

FIG. 1 shows an exemplary network arrangement 100 in which a station may be located. Specifically, the network arrangement 100 may relate to a particular overall area. For example, the network arrangement 100 may be for a portion of a global environment including different networks for the station to join. As such, the network arrangement 100 may be for a particular latitude range and longitude range. However, those skilled in the art will understand that the network arrangement 100 may be more complex to include further available networks within the latitude/longitude range. Therefore, the network arrangement 100 is shown for illustrative purposes only. It should be noted that the network arrangement 100 may also be a portion of a contiguous area. For example, the network arrangement 100 may be for a county of a state in the United States. The network arrangement 100 may have further networks that are also incorporated therein that extends beyond the boundaries shown in FIG. 1.

The network arrangement 100 of FIG. 1 shows a plurality of RAT areas 105-120. Each of the RAT areas 105-120 may represent a network in the network arrangement 100. Thus, the RAT area 105 may be a first operating area of a first network using a first RAT in a corresponding first channel; the RAT area 110 may be a second operating area of a second network using a second RAT in a corresponding second channel; the RAT area 115 may be a third operating area of a third network using a third RAT in a corresponding third channel; and the RAT area 120 may be a fourth operating area of a fourth network using a fourth RAT in a corresponding fourth channel. Those skilled in the art will understand that the RAT, channel and band are separate but related network parameters. For example, as described above, the RAT may include a plurality of channels and bands in which the RAT operates. It should again be noted that the use of four RAT areas 105-120 is only exemplary and the network arrangement 100 in the given area may include fewer or more RAT areas.

The RAT areas 105-120 may be disposed within the network arrangement 100 in such a way that the given overall area within the latitude and longitude ranges includes areas with each area including one or more of the networks. As illustrated in FIG. 1, areas 125-185 may result from the RAT areas 105-120 overlapping with one another. Specifically, the area 125 may include only the RAT of the RAT area 105; the area 130 may include the RATs of the RAT areas 105 and 110; the area 135 may include only the RAT of the RAT area 110; the area 140 may include the RATS of RAT areas 105 and 115; the area 145 may include the RATs of the RAT areas 105, 110, and 115; the area 150 may include the RATs of all the RAT areas 105-120; the area 155 may include the RATs of RAT areas 105, 110, and 120; the area 160 may include the RATs of the RAT areas 110 and 120; the area 165 may include only the RAT of the RAT area 115; the area 170 may include the RATs of the RAT areas 105, 115, and 120; the area 175 may include the RATs of the RAT areas 110-120; the area 180 may include the RATS of the RAT areas 115 and 120; and the area 185 may include only the RAT of the RAT area 120.

It should be noted that each RAT area 105-120 may include one or more BSs for the station to associate therewith to join the corresponding network. Accordingly, the station may be configured to communicate with respective BSs in the RAT areas 105-120. For example, the RAT area 105 may only have a single BS with which the station is capable of communicating. In another example, the RAT area 110 may have more than three BSs with which the station is capable of communicating. Each BS may have a respective operating area such that the combination of the respective operating areas provides the RAT area.

There are multiple RATs that include a variety of different technologies. For example, the RAT may be for a Global System for Mobile Communications (GSM) network, a Universal Mobile Telecommunications System (UMTS), a Time Division Synchronous (TD-S) Code Division Multiple Access (CDMA) (TD-SCDMA) network, a Long Term Evolution (LTE) network, a CDMA network, a Data Only (DO) network, etc. Within each type of RAT, there may be a plurality of bands that are supported by the network. For example, in the GSM network, four bands may be supported; in the Wideband CDMA (WCDMA) network, five bands may be supported; in the LTE network, over ten bands may be supported; etc. When the station is in a given location in which different networks use a respective RAT operating on a respective channel, the station may identify these networks from performing a search or a scan on the channel/frequency. For example, a ping request may be broadcast on each channel and a ping response may be transmitted from the network. The station may also become aware of the RAT that is being utilized to determine whether the station is capable of joining the network (if the RAT is supported by the station).

Each network operating in the different locations may be a Public Land Mobile Network (PLMN). The PLMN is a regulatory term used in telecommunications representing a network established and operated by an administration or by a recognized operating agency for the specific purpose of providing land mobile telecommunications services to the public. As discussed above, the PLMN may include an operating area operating on a predetermined channel and utilizing a predetermined RAT (and/or band and/or channel). Once the station has identified the available networks in the location that the station is disposed, the station may join a network in the given area by using a PLMN selection process. For example, among the available PLMNs, a priority determination may be performed for the PLMN selection process.

The exemplary embodiments provide a location aware PLMN selection (LAPS) application that performs the PLMN selection process based upon the location in which the station is disposed. By using the location of the station, the LAPS application may streamline the process of identifying the available PLMNs in the location as well as selecting the most optimal, available PLMN. As will be described in further detail below, the station may reference a LAPS database that indicates expected networks that are available such that the LAPS application may scan the corresponding channels of these expected networks. In this manner, the station is not required to scan across the entire range of channels. Accordingly, the station may conserve power, reduce the time required to join a network, and improve the overall user experience. As will also be described in further detail below, the LAPS application may include features that further improve upon the PLMN selection process.

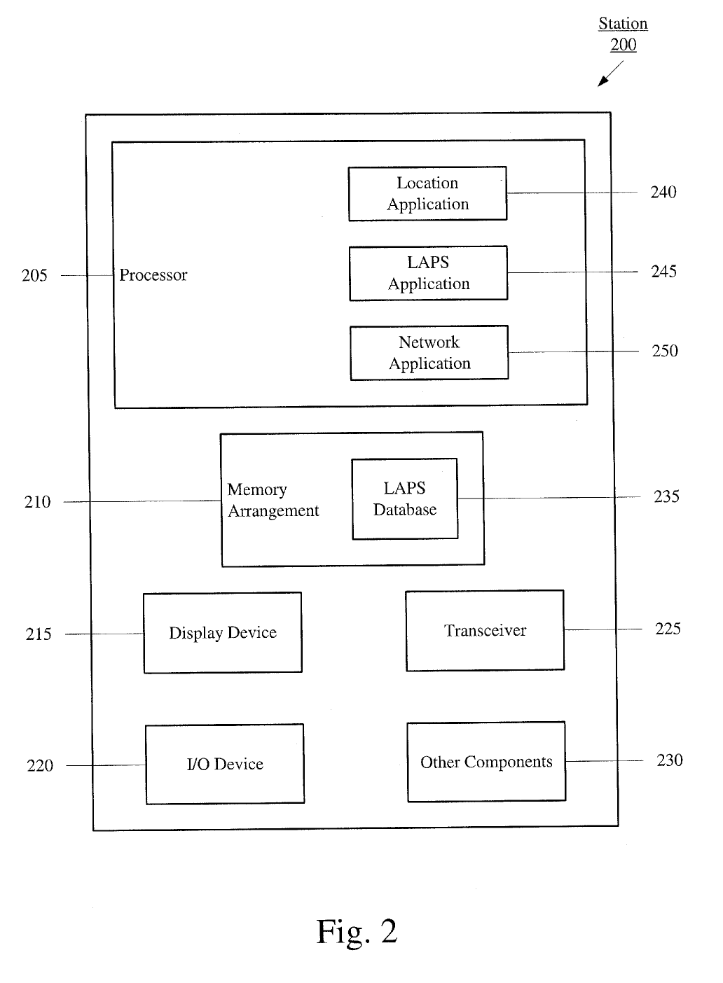

FIG. 2 shows an exemplary station 200 configured to perform a network selection based upon a location of the station. Specifically, the station 200 may perform the LAPS process to identify available networks and join one of these networks. The station 200 may be any electronic component configured to join a network. For example, the station 200 may be a portable device such as a cellular phone, a smartphone, a tablet, a phablet, a laptop, etc. Accordingly, the station 200 may be configured to supposed one or more different network technologies that may correspond to the different RATS used in the network arrangement 100 or otherwise used by a network. The station 200 may include a processor 205, a memory arrangement 210, a display device 215, an input/output (I/O) device 220, a transceiver 225, and other components 230 such as a portable power supply, an audio (I/O) device, etc.

The processor 205 may be configured to execute a plurality of applications of the station 105. For example, the applications may include a web browser when connected to a communication network via the transceiver 225. In other examples and according to the exemplary embodiments, the applications may include a location application 240, a LAPS application 245, and a network application 250. The location application 240 may be used to determine the location in which the station 200 is disposed. The network application 250 may be used to join a PLMN from a selection determined by the LAPS application 245. The LAPS application 245 may perform a targeted scan to identify the available PLMNs and provide the PLMN selection to the network application 250 based upon the location determined by the location application 240.

It should be noted that the processor 205 may include an applications processor and/or a baseband processor and the different application described herein may be executed on either type of processor as software or firmware. It should also be noted that the location application 240, the LAPS application 245, and/or the network application 250 being applications (e.g., a program) executed by the processor 205 is only exemplary. The functionality of these applications 240-250 may also be represented as a separate incorporated component of the station 200 or may be a modular component coupled to the station 200.

The memory arrangement 210 may be a hardware component configured to store data related to operations performed by the station 200. Specifically, the memory arrangement 210 may store a LAPS database 235 that is used by the LAPS application 245 to determine the PLMN selection. The LAPS database 235 will be described in further detail below. The memory arrangement 210 may also store further data such as a location database, the location determined by the location application 240, specific details of the location, etc. The display device 215 may be a hardware component configured to show data to a user while I/O device 220 may be a hardware component configured to receive inputs from the user and output corresponding data. The other components 230 may include a portable power supply (e.g., battery), a data acquisition device, ports to electrically connect the station 200 to other electronic devices, etc.

The transceiver 225 may be a hardware component configured to transmit and/or receive data. That is, the transceiver 225 may enable communication with other electronic devices. Specifically, the transceiver 225 may be used by the location application 240 to determine the location of the station 200, used by the LAPS application 245 to identify available PLMNs at the location of the station 200, and used by the network application 250 to join the selected PLMN. The transceiver 225 may be used to operate on a variety of different frequencies or channels (e.g., set of consecutive frequencies) that are related to the RATs in the network arrangement 100.

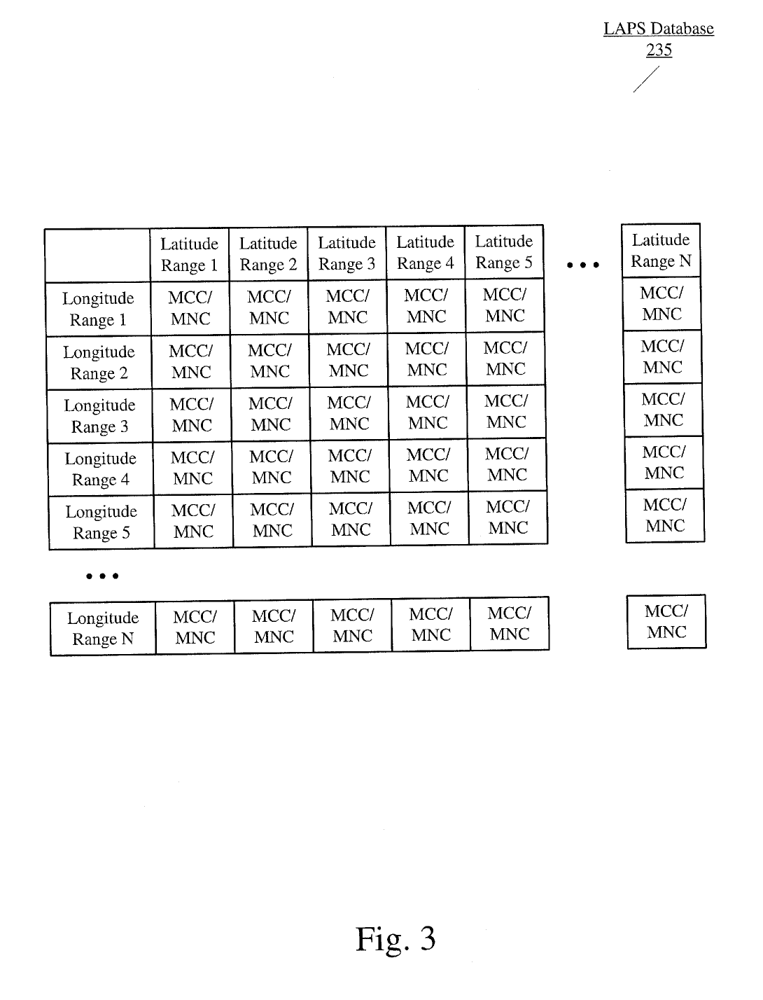

The LAPS database 235 may be a set of data stored in the memory arrangement 210 that indicates the one or more PLMNs that are available for the station 200 to join based upon a location of the station 200. FIG. 3 shows an exemplary LAPS database 235 used by the LAPS application 245. The LAPS database 235 may relate to the network arrangement 100. The LAPS database 235 may provide the PLMNs based upon a geographic location (hereinafter “geolocation”). As shown in FIG. 3, the exemplary LAPS database 235 may include a plurality of columns for different latitude ranges and a plurality of rows for different longitude ranges. With regard to the network arrangement 100, the latitude ranges and the longitude ranges may include the entire latitude/longitude range for the area shown in network arrangement 100. The different combinations of latitude ranges and longitude ranges may include different PLMNs. Specifically, the different PLMNs in each latitude/longitude range combination may include cellular related data. As discussed above, the cellular related data may be for a specific area such as that shown for the network arrangement 100. The cellular related data may also relate to the geolocation for the entire world. As shown in FIG. 3, the cellular related data may include a mobile country code (MCC) and a mobile network code (MNC). However, the cellular related data may further include a network band, a carrier frequency, a location area code (LAC), a tracking area code (TAC), a cellular identification (cellid), etc.

The combination of the MCC and the MNC may be used to identify a network operator (e.g., Verizon, AT&T, T-Mobile, Sprint, etc.) and the RAT and band being used (e.g., GSM 1900, GSM 850, CDMA2000 800, etc.). For example, in the United States, the MCC may be 310. With the MCC of 310, the MNC may be 030 which indicates the AT&T network using the GSM band 850. Accordingly, the MCC/MNC combination indicates a single country/network. The MCC/MNC may be a known set of data that may be available to any mobile carrier such that this data may also become available to the station 200. For example, the station 200 may be a mobile phone in which the user registers with a mobile carrier to be provided cellular service for the station 200. The country indicated by the MCC may also be used to derive latitude and longitude values. For example, the MCC may correspond to a combination of latitude ranges and longitude ranges. Such ranges may are shown in the LAPS database 235.

The LAPS database 235 may further include the network band, the carrier frequency, the LAC/TAC, the cellid, etc. Using the above example, the LAPS database 235 may also include the GSM band 850 as the network band, which corresponds to an uplink frequency range of 824.2-849.2 MHz and a downlink frequency range of 869.2-894.2 MHz as well as a channel number range of 128-251. The above example may further include the LAC representing a 16 bit number that further identifies the location area of the PLMN. Those skilled in the art will understand that a location area identity (LAI) may be derived from the MCC, the MNC, and the LAC. The tracking area code (TAC) is a broadcast related to an LTE network, in which each enhanced Node B (eNB) of the network broadcasts the TAC to indicate a tracking area to which the eNB belongs. Each PLMN has a unique set of TACs. A combination of the PLMN and the TAC results in a unique Tracking Area Identity (TAI) that identifies a specific area for the PLMN.

The LAPS database 235 may be generated in a variety of manners. As shown in FIG. 3, the LAPS database 235 may have the columns and rows of latitude and longitude ranges. The resulting cells may include the MCC/MNC information corresponding to the combination of latitude and longitude ranges. In another example, the resulting cells may also include all the other cellular related information described above. In yet another example, the LAPS database 235 may include a plurality of databases. Specifically, there may be a first one of the LAPS database 235 such as that shown in FIG. 3. There may also be at least one second one of the LAPS database 235 that indicates the other types of cellular related information. Accordingly, there may be a first LAPS database for the MCC/MNC information, a second LAPS database for the band and/or carrier frequency information, a third LAPS database for the LAC/TAC information, a fourth LAPS database for the cellid information, etc. The use of a plurality of LAPS databases may be used when, for example, the categories of the cellular related information is not coincident upon the exact same latitude/longitude range combinations.

When the LAPS database 235 is generated and stored in the memory arrangement 210, the LAPS application 245 may reference the LAPS database 235 using a location determined by the location application 240. Specifically, a corresponding latitude/longitude combination may be determined for the location and applied to the LAPS database 235. The specific latitude/longitude combination may therefore indicate the PLMNs that are available for the station 200 at the location as indicated by the LAPS database 235. The latitude/longitude may be, for example, a number for degrees, minutes, seconds, and milliseconds.

The LAPS application 245 may use different location granularities depending on a variety of factors existing at the time the PLMN selection process is occurring. As shown in the LAPS database 235, the location granularities may be MCC and/or MNC based. For example, when located within a country and not relatively near a border thereof, the MCC/MNC combination may be used. In another example, when located within near a border of a country, the MCC/MNC combination may also be used but the LAPS application 245 may further consider neighboring MCCs and MNCs. Specifically, a predetermined number of latitude and longitude ranges beyond those defining the borders of the country may be used. In other examples, depending on the various factors, the location granularities may be PLMN based, LAC based, cellid based, etc.

The LAPS database 235 may be provided to the station 200 in a variety of manners. In a first example, the LAPS database 235 may be stored in the memory arrangement 210 prior to deployment of the station 200. In a second example, the station 200 may receive the LAPS database 235 upon an initial connection or registering with a home network. Specifically, when the station 200 joins its home network (e.g., corresponding to the provider the user has registered), the LAPS database 235 may be transmitted from a storage unit of the home network to the station 200 and stored in the memory arrangement 210. After receiving the LAPS database 235, the data may be periodically updated. In a first example, the station 200 may update the data of the LAPS database 235 independently. For example, the station 200 may store PLMNs and other cellular related data which has been joined by the station 200. In a second example, the station 200 may join a network and transmit a query with an identity of its current version of the LAPS database 235. If a newer or updated version of the LAPS database 235 is available, the station 200 may receive the new LAPS database 235 or receive the updates thereto. When the LAPS application 245 performs the PLMN selection, the LAPS database 235 that is currently stored in the memory arrangement 210 may be used.

The data in the LAPS database 235 may be used by the LAPS application 245 in a variety of manners. In a first example, the data of the LAPS database 235 may be used in a static manner. That is, the LAPS database 235 may be used in its entirety without narrowing the fields. Thus, the data of the LAPS database 235 may not change with the geolocation that is determined. In a second example, the data of the LAPS database 235 may be used in a dynamic manner. That is, the LAPS database 235 may be used to narrow the fields. For example, the geolocation may indicate the MCC. By knowing the MCC, the country in which the station 200 is located may indicate the latitude and longitude ranges that correspond to the country. The LAPS application 245 may narrow the fields of the LAPS database 235 to be only within these ranges. However, it should be noted that the narrowing of the fields may also include a buffer such as to address scenarios when the geolocation indicates the station 200 is located near a border of the country. Thus, several columns/rows of latitudes/longitudes may also remain in the dynamic manner for a neighboring area or neighboring country.

According to the exemplary embodiments, the LAPS application 245 may perform a PLMN selection process to determine the PLMN that the station 200 is to join based upon the location of the station 200. The LAPS application 245 may also initially perform a scan to determine the available PLMNs based upon a selected search of channels as indicated in the LAPS database 235. In this manner, the LAPS application 245 configures the station 200 to perform a targeted scan in these known channels corresponding to known networks existing at the location at which the station 200 is disposed.

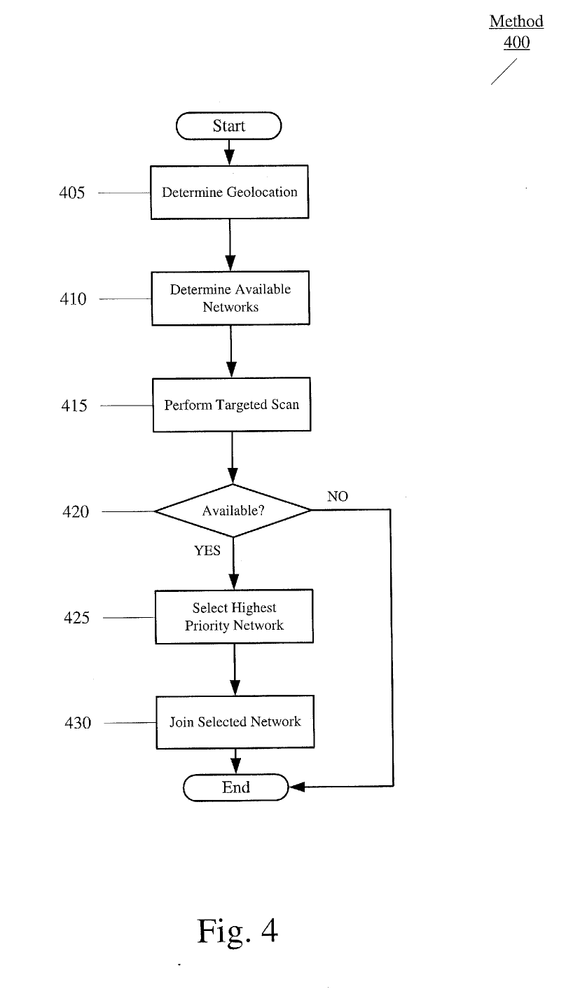

FIG. 4 shows an exemplary method 400 for performing a network selection based upon a geolocation of the station 200. The exemplary method 400 will be described with reference to the network arrangement 100 of FIG. 1, the station 200 of FIG. 2 and the LAPS database 235 of FIG. 3.

In step 405, the location application 240 of the station 200 determines the geolocation of the station 200. The location application 240 may determine the location of the station 200 in a variety of different ways. In a first example, the location application 240 may use a Global Positioning System (GPS). More generally, the location application 240 may use a satellite based tracking system. Using signals received on four or more satellites, the geolocation of the station 200 may be determined. In a second example, the location application 240 may use a Local Positioning System (LPS) such as a triangulation system. More generally, the location application 240 may use local network components and signal parameters to determine the location. By receiving a signal from three or more network components such as BSs and determining a respective signal strength such as a received signal strength indicator (RSSI), the geolocation of the station 200 may be determined. In a third example, the location application 240 may receive the location of the station 200 through any device that is capable of determining the location of the station 200 and providing this information thereto. For example, the station 200 may be in a local WiFi network that provides this functionality. In another example, the station 200 may have access to a Real-Time Locating System (RLTS) that provides this functionality. In a fourth example, the location application 240 may have stored a previous location of the station 200 in the memory arrangement 210 when the location application 240 was capable of determining the location. Based upon a predetermined timer or other criteria, the location application 240 may use the previous location as an estimate of the current location of the station 200. For example, if only a few seconds has passed (which is less than the predetermined timer value), the location application 240 may use the previous known location. It should be noted that the above manners of determining the location of the station 200 are only exemplary. The exemplary embodiments relate to any manner of determining the location of the station 200 and using this location information for subsequent purposes. It should also be noted that the station 200 may not be required to join a PLMN in order to determine its location.

To provide a specific example that will be carried out throughout the description of method 400, it may be determined in step 405 that the station 200 is within the area 130 of the network arrangement 100.

In step 410, the LAPS application 245 of the station 200 determines the existing PLMNs in the geolocation as indicated in the LAPS database 235. As discussed above, the LAPS application 245 may derive a latitude and longitude corresponding to the geolocation. Using this information, the LAPS application 245 may reference the LAPS database 235 to determine the cellular related data at this geolocation, namely the known available PLMNs. As also described above, other cellular related data may include a network band, a carrier frequency, a location area code (LAC), a type allocation code (TAC), a cellular identification (cellid), etc.

Continuing with the example started above of the station being located in area 130, in step 410 the LAPS application 245 may query the LAPS database 235 with the geolocation data and this may indicate that there are two PLMNs that correspond to this geolocation. Specifically, the area 130 has the overlapping RAT area 105 and the RAT area 110.

In step 415, the LAPS application 245 performs a targeted scan based upon the known PLMNs in the geolocation. Since the LAPS application 245 is aware of these PLMNs and the RAT/channel at which these PLMNs operate based on the information that is stored in the LAPS database 235 and the identified geolocation, the LAPS application 245 may instruct the station 200 to perform a targeted scan. For example, the LAPS application 245 may instruct an RF front-end of a baseband processor (e.g., processor 205) in conjunction with the transceiver to perform the scan on only the channels of these identified PLMNs for the geolocation. Continuing with the example started above of the station 200 being located in area 130, the station 200 may perform the targeted scan based on the cellular related data in the LAPS database 235 for the PLMNs corresponding to the RAT area 105 and the RAT area 110.

In step 420, if no PLMNs are identified as available, the method 400 may end. This does not necessarily mean that no PLMNs are available. Rather, this means that the limited scan based on the PLMN data available in the LAPS database 235 for the identified geolocation did not result in finding any available PLMNs. This may be the result of, for example, the LAPS database being out of date, the determined geolocation not being accurate, etc. Even though the method 400 is completed, the station 200 may scan all available frequencies and channels to identify if any PLMNs are available.

In the current example, it may be considered that both the PLMNs corresponding to the RAT area 105 and the RAT area 110 are identified as available. In such a case, the LAPS application 245 may direct the station 200 to discontinue any further scans on other channels corresponding to further PLMNs that do not exist in the area 130. That is, if the station 200 identifies as available, any of the PLMNs identified for the geolocation, there is no need for the station to continue to use processor resources and power resources to scan for additional PLMNs.

If one or more PLMNs are identified, the method 400 continues to step 425. In step 425, the LAPS application 245 selects a highest priority PLMN from a list generated of the available, existing PLMNs. In a first example, the memory arrangement 210 may further include a priority database (not shown) that indicates a preference for one PLMN over another PLMN. Thus, using this priority database, the LAPS application 245 may perform the PLMN selection. The priority database may also be used dynamically. For example, when in a first country having a first MCC, the priority database may indicate that a first PLMN is preferred over a second PLMN. However, when in a second country having a second MCC, the priority database may indicate that the second PLMN is preferred over the first PLMN. In a second example, the RSSI of the response may be used. The RSSI value that is greatest may indicate a most optimal connectivity for the station 200. Those skilled in the art will understand that there may be other manners of prioritizing PLMNs. In the example started above, it may be considered that the PLMN corresponding to RAT area 105 is the higher priority network. Thus, the LAPS application 235 may select the PLMN corresponding to RAT area 105 for connection.

In step 430, the station 200 joins the selected PLMN by performing an association process with a corresponding network component (e.g., base station). The LAPS application 245 may provide the PLMN selection to the network application 250. The network application 250, in conjunction with the RF front-end and of the baseband processor and the transceiver 225 may perform an association process with the network component to join the corresponding network. For example, a handshake procedure may be performed. To complete the example started above, the station 200 may join the PLMN corresponding to RAT area 105 by connecting to a base station of this network.

As will be described in further detail below, the LAPS application 245 may utilize further data depending on different scenarios related to the geolocation of the station 200 to perform the PLMN selection that may further conserve power and/or reduce a time required to join a PLMN at the geolocation.

It should be noted that the LAPS database 235 may include all PLMNs that are known to exist in a given geolocation. The memory arrangement 210 may therefore also include a RAT database (not shown) that indicates all technologies that are supported by the station 200. When the list of available networks at the geolocation is generated, the LAPS database 235 may reference the RAT database to further determine whether any of the available PLMNs use a RAT that is supported by the station 200. By omitting those PLMNs using a RAT that is not supported by the station 200, the PLMN selection may be performed in a more efficient manner.

It should also be noted that the LAPS database 235 may be adjusted for the technologies supported by the station 200 or other criteria. The updating of the LAPS database 235 may further allow the station 200 to conserve power and reduce a time to join a network. For example, the LAPS database 235 may be provided independent of the capabilities of the station 200. Therefore, the LAPS database 235 may include all available networks at a geolocation. The LAPS application 245 may process the LAPS database 235 and generate a station-specific LAPS database. The station-specific LAPS database may remove all PLMNs that utilize a RAT that is not supported by the station 200. In this manner, the LAPS application 245 may remove PLMNs that the station 200 is incapable of joining. Subsequently, the LAPS application 245 may instruct the station to scan for only those networks that are available and also operate using a RAT supported by the station 200. Accordingly, more power may be conserved as less scans are required. The station-specific LAPS database may be generated by the LAPS application 245 or may be provided using the above identified manners.

The LAPS application 245 may also provide a push or a fetch mechanism to be used in the PLMN selection. The push mechanism may be used as a first manner of providing the data in the LAPS database 235 corresponding to the geolocation. Specifically, the geolocation is used to determine corresponding LAPS data that is pushed to the LAPS application 245. Thus, the LAPS data may be pushed to the LAPS application 245 whenever it is necessary. The fetch mechanism may be used as a second manner of providing the data in the LAPS database 235. The fetch mechanism may provide visible network information that may be used by the location application 240 to expedite the geolocation determination. For example, if the LAPS is used, the LAPS application 245 may have received cellular related information from the network components. This information may be attached to a LAPS Data Request forwarded to the LAPS database 235 and the location application 240. The location application 240 may utilize this visible cellular information to more efficiently (e.g., reduce time needed) determine the geolocation. It should be noted that if the fetch mechanism is used, the method 400 may include another step in which the location application 240 receives visible cellular data.

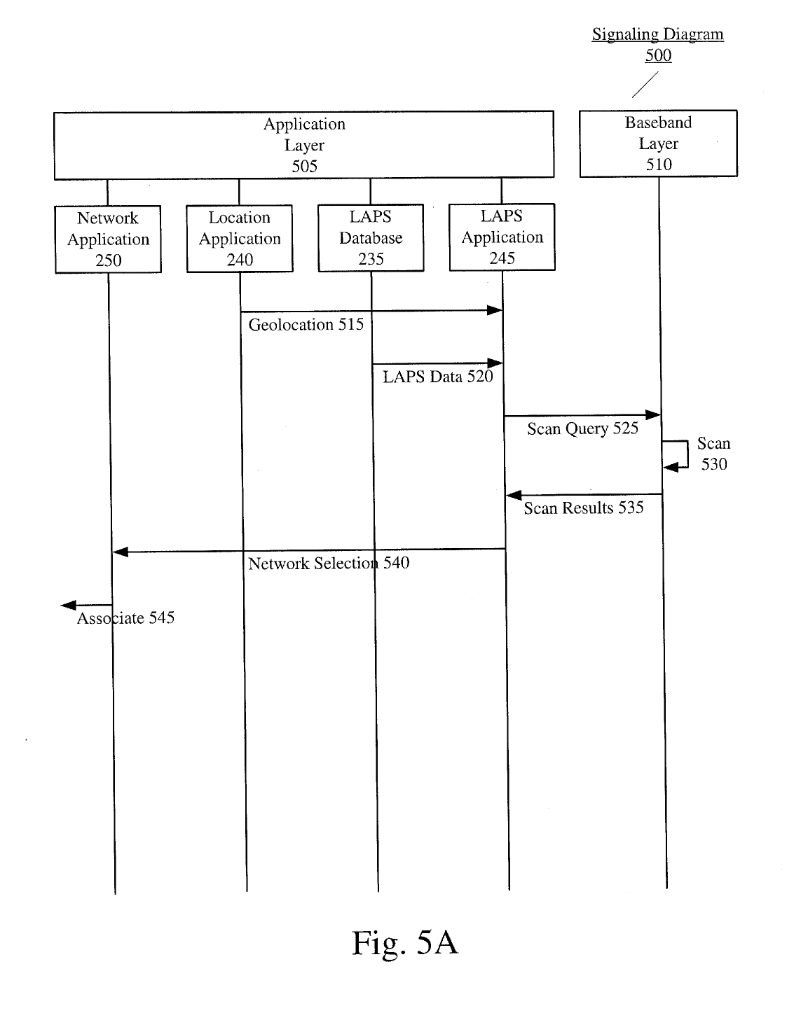

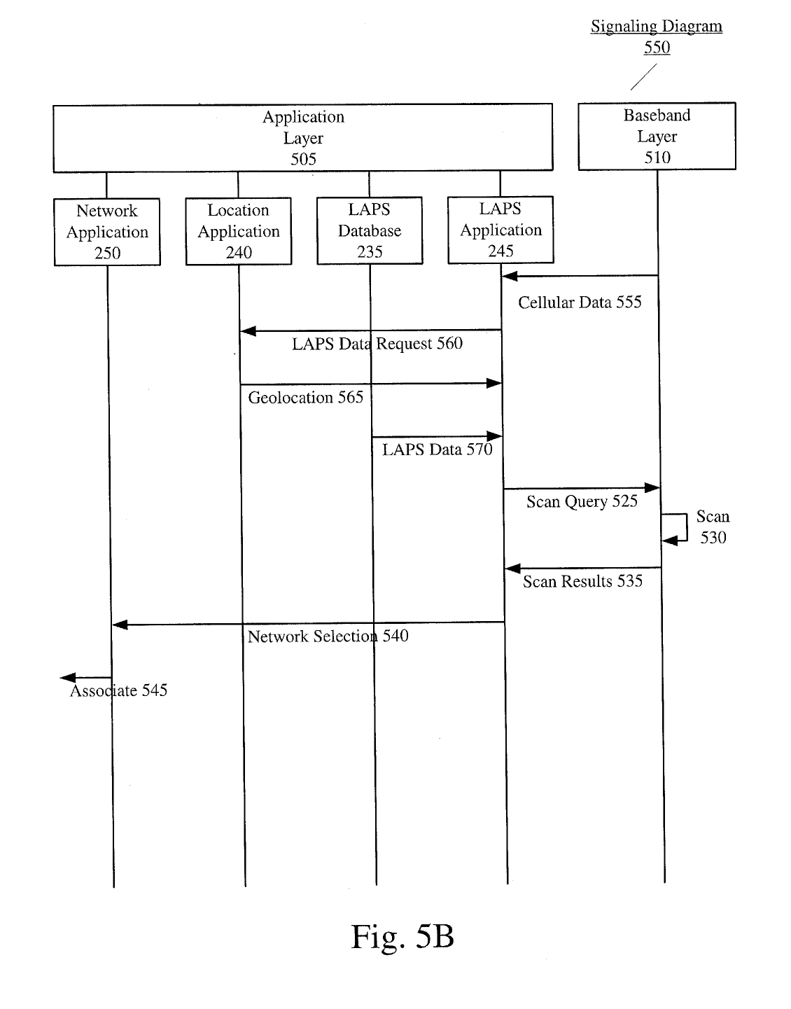

FIG. 5A shows a first exemplary signaling diagram 500 to perform a PLMN selection based upon a geolocation of the station 200. Specifically, the signaling diagram 500 relates to the above described push mechanism being utilized. The signaling diagram 500 constructively illustrates an application layer 505 and a baseband layer 510. As described above, the processor 205 may be a baseband processor that implements the baseband layer 510 and application layer 505. In another example, the application layer 505 may be implemented by a first processor (e.g. an applications processor) and the baseband layer 510 may be implemented by a second processor (e.g., baseband processor). As shown, the application layer 505 executes the network application 250, the location application 240, and the LAPS application 245 and accesses the LAPS database 235.

Using the push mechanism and the above-described manner of performing a targeted scan and a subsequent PLMN selection, the location application 240 may first provide the geolocation information 515 to the LAPS application 245. Again, the location application 240 may use any manner of determining the geolocation. The LAPS data 520 may then be pushed from the LAPS database 235 to the LAPS application 245. The LAPS data 520 that is pushed may be in any form such as the static or dynamic form described above. Once the LAPS application 245 receives the geolocation 515 and the LAPS data 520, the LAPS application 245 may determine the existing PLMNs at the geolocation. Accordingly, the LAPS application 245 may forward a scan query 525 to the baseband layer 510. The scan query 525 may relate to the channels corresponding to a RAT for each PLMN. Thus, the baseband layer 510 may perform the targeted scan 530 on these known channels to identify the available PLMNs. After the targeted scan 530 is performed, the scan results 535 may be provided to the LAPS application 245. The LAPS application 245 may generate the PLMN list from the scan results 535 and select the PLMN that the station 200 is to join. The PLMN selection 540 may be forwarded to the network application 250 to associate 545 with the network component corresponding to the PLMN selection 540.

FIG. 5B shows a second exemplary signaling diagram 550 to perform a PLMN selection based upon a geolocation of the station 200. Specifically, the signaling diagram 550 relates to the above described fetch mechanism being utilized. The signaling diagram 550 also constructively illustrates the application layer 505 and the baseband layer 510 in the same manner as described above for the signaling diagram 500.

Using the fetch mechanism and the above-described manner of performing a targeted scan and a subsequent PLMN selection, the baseband layer 510 may first provide some cellular data 555. The cellular data 555 may be for any local network data at the geolocation in which the station 200 is disposed. For example, as discussed above, the cellular data 555 may relate to the LPS. The LAPS application 245 may forward a LAPS data request 560 that may include the cellular data to the location application 240. By providing this visible cellular data, the location application 240 may be able to more quickly determine the geolocation as further information is available in ascertaining the geolocation. The geolocation 565 may be provided to the LAPS application 245. Subsequently, the LAPS data 570 corresponding to the geolocation may be provided to the LAPS application 245. In this manner, the geolocation 565 and the LAPS data 570 is provided to the LAPS application 245 in a more efficient and faster manner. Subsequently, a substantially similar process as described with reference to signaling diagram 500 including the scan query 525, the scan 530, the scan results 535, the network selection 540 and the association 545 for identifying the existing PLMNs to perform the targeted scan, the PLMN selection and association processes.

The exemplary manner of performing the PLMN selection and performing the targeted scan may apply to a variety of different scenarios. Depending on the scenario, the targeted scan and PLMN selection as described in the exemplary manner may be used and adapted to further improve upon how the station 200 joins the selected PLMN. Exemplary scenarios described herein may include a power-up state in a home or roam environment, an out-of-service (OOS) recovery state, a background search using a high priority (HP) PLMN search or a manual search, a foreground search, and a system avoidance configuration.

In a first example, the station 200 may in a power-up state in a home environment. The power-up state may relate to any time that the PLMN is selected which may include the station 200 being activated, a toggling between an “airplane mode”, a subscriber identity module (SIM) card hotswap, etc. When in a power-up state in the home environment, the station 200 may use a specific targeted scan and PLMN selection process. In this particular example, a substantially similar manner described above may be used. The home network of the station 200 may support a plurality of RATs but the RATs may not be evenly deployed. For example, a 3^{rd} Generation Partnership Project (3GPP) carrier may support several 3GPP RATs, GSM RATs, UMTS RATs, LTE RATs, etc. such that the coverage may be near 90% within the home environment for GSM RATs, be near 50% within the home environment for WCDMA RATs, be near 20% within the home environment for LTE RATs, etc. The LAPS application 245 may avoid searching for PLMNs that are not present in the geolocation of the station 200. The LAPS application 245 may also provide a quick targeted scan on the carrier frequencies deployed in the geolocation to quickly acquire service for the station 200. The LAPS data from the LAPS database 235 may be provided through the push or fetch mechanism for this example.

In a second example, the station 200 may be in a power-up state in a home environment. When in a power-up state in the home environment, the station 200 may also use a specific targeted scan and PLMN selection process that may be substantially similar to that described above. When roaming, the station 200 often takes a substantially long period of time to search across an entire frequency range for supported bands to identify the available PLMNs at the geolocation, particularly since the station 200 does not have access to this information until a scan is performed directly by the station 200. The LAPS application 245 may generate the list of available PLMNs by performing the targeted scan using the LAPS data in the LAPS database 235. The LAPS application 245 may also quickly perform the PLMN selection as the list of available PLMNs is generated in a shorter time period. Particularly for a roam environment, the LAPS application 245 may scan the carrier frequency for the selected PLMN and camp thereon to acquire service. The LAPS data from the LAPS database 235 may also be provided through the push or fetch mechanism for this example.

In a third example, the station 200 may be in an OOS recovery state. The OOS recovery state may relate to when the station 200 loses service due to any number of reasons. The station 200 ordinarily searches across the entire frequency range for supported bands to identify the available PLMNs at the geolocation in order to reacquire service. If the station 200 is OOS for an extended period of time and performs this extensive search during this time, the power consumption becomes very high and service acquisition time is also compromised as the station 200 needs to hibernate or sleep to conserve its limited power supply. The LAPS application 245 enables the use of knowledge of cellular deployments, particularly at the geolocation of the station 200 where service is lost and nearby vicinities. The LAPS application 245 may perform the targeted scan to reacquire service in a more time efficient manner that does not require the extensive use of its limited power supply. The LAPS application 245 may also perform the targeted scan for PLMNs in the vicinity area to further quickly reacquire service.

In a fourth example, the station 200 may use a background search including a HP-PLMN search. A HP-PLMN search may occur when the station 200 camps on a Visited PLMN (VPLMN). The VPLMN may be a network that may incur roaming charges. This happens periodically when a search timer to join a PLMN expires. The search timer is configured by a carrier (e.g., the one subscribed to by the user) and stored in the SIM card. If the search timer is configured too short (e.g., 6 minutes), the station 200 may consume a substantial amount of power. If the search timer is configured too long (e.g., 1 hour or longer), the station 200 may remain in the VPLMN for too long that results in extensive roaming charges being assessed. The LAPS application 245 may address this scenario by only triggering the targeted scan in the geolocation where a higher priority PLMN may be present (as indicated by the LAPS database 235). For example, if roaming to a neighbor country, the station 200 may avoid searching for its Home PLMN (HPLMN) if far away from the border area. After entering the border area, the LAPS application 245 may being searching for its HPLMN. Accordingly, the effects of the search timer may be addressed using the LAPS application 245. Therefore, the LAPS application 245 may only trigger the targeted scan in the geolocation where the higher priority PLMN may be present independently of the search timer.

In a fifth example, the station 200 may use a background search including a manual search. The manual search may be triggered by a user of the station 200. The manual search ordinarily performs a full band scan on all supported RATs. This process takes a substantial amount of time and also consumes a large amount of power. The LAPS application 245 may avoid the full band search that is otherwise used in the manual search. Specifically, with the knowledge of the RAT, band, carrier frequencies, etc. at the geolocation, the manual search may be changed to use the targeted scan. Furthermore, with the knowledge of the existing PLMNs at the geolocation, the LAPS application 245 may terminate a scan when all possible PLMNs have already been identified.

In a sixth example, the station 200 may use a foreground search. Specifically, the foreground search may relate to a Better System Selection (BSR) in a multi-mode station. In a multi-mode device, BSR is a foreground search. For 1X/DO systems, the search may be performed quickly but for the 3GPP system, the search may take a substantial amount of time. If the 3GPP system such as LTE has a higher priority than the 1X/DO system as per the configuration of the station 200, the searching itself may result in missing page or mobile terminated (MT) calls. The LAPS application 245 may perform the targeted scan only when the better system is known to be available as indicated in the LAPS database 235. The targeted scan also only performs the scan on known channels that improves the efficiency of performing the scan.

In a seventh example, the station 200 may use a system avoidance configuration. The system avoidance configuration may also relate to a multi-mode device. In the multi-mode device, the 3GPP2 mode is more often utilized in its home country while the 3GPP mode is used in other countries. In this case, the home country 3GPP system (including GSM, WCDMA, TS-SCDMA) should be avoided. The LAPS application 245 may include such information in the LAPS database 235 such that the station 200 may safely avoid Global Wireless Technologies (GWT) in its home country, particularly if sufficiently far away from a border of the home country. The same may also apply in vice versa when in a non-home country.

The exemplary embodiments provide a station and method for a location aware PLMN selection. A LAPS database may include a variety of data to indicate existing PLMNs within different geolocations. The different geolocations included in the LAPS database may be global or local. By determining the geolocation of the station, a LAPS application may first determine the existing PLMNs at the geolocation as indicated in the LAPS database. From the knowledge of the existing PLMNs, the LAPS application may perform a targeted scan in channels and RATs corresponding to the existing PLMNs. The targeted scan may identify the available PLMNs at the geolocation. The LAPS application may perform a PLMN selection such that the station joins the selected PLMN. In this manner, extensive scanning or searching (particularly across an entire frequency range) may be avoided in which a scan on a channel for a non-existing PLMN at a particular geolocation is not performed. Accordingly, a more time-efficient manner that consumes less power is used for the PLMN selection process.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Mac platform and MAC OS X, mobile platforms having operating systems such as iOS. Android, etc. In a further example, the exemplary embodiments of the above described method may be embodied as a program containing lines of code stored on a non-transitory computer readable storage medium that, when compiled, may be executed on a processor or microprocessor.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalent.

What is claimed is:

1. A method comprising:
at a station:
determining a geographic location of the station;
determining at least one predetermined Public Land Mobile Network (PLMN) in the geographic location by comparing the geographic location to a database including stored geographic locations and PLMNs known to be present within each of the geographic locations;
performing a targeted scan on select channels corresponding to the at least one predetermined PLMN to identify at least one available PLMN from among the at least one predetermined PLMN; and
selecting one of the at least one available PLMN for the station to join.

2. The method of claim 1, wherein the geographic locations of the database includes a plurality of latitude ranges and a plurality of longitude ranges.

3. The method of claim 2, wherein the PLMNs known to be present in a corresponding geographic location is identified using at least one of a mobile country code, a mobile network code, a network band, a carrier frequency, a location area code, a type allocation code, and a cellular identification.

4. The method of claim 1, further comprising:
updating the database by only including PLMNs using a Radio Access Technology (RAT) that is supported by the station.

5. The method of claim 1, further comprising:
retrieving select information in the database based upon the geographic location to determine the at least one predetermined PLMN.

6. The method of claim 5, wherein the select information is information relating to a predetermined distance surrounding the geographic location.

7. The method of claim 1, wherein the one of the at least one available PLMN is selected based upon a priority of the available PLMN.

8. The method of claim 7, wherein the priority is determined based on a stored priority or an operating characteristic of the PLMN.

9. The method of claim 1, wherein the PLMN operates using a RAT corresponding to a Global System for Mobile Communications (GSM) network, a Universal Mobile Telecommunications System (UMTS) network, a Time Division Synchronous (TD-S) Code Division Multiple Access (CDMA) (TD-SCDMA) network, a Long Term Evolution (LTE) network, a CDMA network, and a Data Only (DO) network.

10. A station, comprising:
a transceiver configured to establish a connection with a Public Land Mobile Network (PLMN); and
a processor;
wherein the processor and transceiver are configured to perform a PLMN selection by:
determining a geographic location of the station;
determining at least one predetermined Public Land Mobile Network (PLMN) in the geographic location;
performing a targeted scan on select channels corresponding to the at least one predetermined PLMN to identify at least one available PLMN from among the at least one predetermined PLMN; and
selecting one of the at least one available PLMN for the station to join.

11. The station of claim 10, further comprising:
a memory arrangement configured to store a database including a plurality of geographic locations and at least one respective PLMN known to be present therein.

12. The station of claim 11, wherein the geographic locations of the database includes a plurality of latitude ranges and a plurality of longitude ranges.

13. The station of claim 12, wherein the PLMNs known to be present in a corresponding geographic location is identified using at least one of a mobile country code, a mobile network code, a network band, a carrier frequency, a location area code, a type allocation code, and a cellular identification.

14. The station of claim 11, wherein the processor is further configured to update the database by only including PLMNs using a Radio Access Technology (RAT) that is supported by the station.

15. The station of claim 11, wherein the processor is further configured to retrieve select information in the database based upon the geographic location to determine the at least one predetermined PLMN.

16. The station of claim 10, wherein the one of the at least one available PLMN is selected based upon a priority of the PLMN, wherein the priority is determined based on a stored priority or an operating characteristic of the PLMN.

17. A non-transitory computer readable storage medium with an executable program stored thereon, wherein the program instructs a microprocessor to perform operations comprising:
determining a geographic location of a station;
determining at least one predetermined Public Land Mobile Network (PLMN) in the geographic location;
performing a targeted scan on select channels corresponding to the at least one predetermined PLMN to identify at least one available PLMN from among the at least one predetermined PLMN; and
selecting one of the at least one available PLMN for the station to join.
